(19) United States
(12) Patent Application Publication
(10) Pub. No.: US 2001/0026702 A1
(43) Pub. Date: Oct. 4, 2001

(54) Image forming apparatus

(75) Inventor: Yoshihiro Nanjo, Mishima-shi (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: Toshiba Tec Kabushiki Kaisha, Tokyo (JP)

(21) Appl. No.: 09/817,462

(22) Filed: Mar. 26, 2001

(30) Foreign Application Priority Data
Mar. 29, 2000 (JP) 2000-091381

(51) Int. Cl. G03G 21/20

(52) U.S. Cl. 399/92; 399/93

(57) ABSTRACT

An image forming apparatus includes an outer housing having an external communication opening, a transfer unit for transferring a recording medium from a lower portion of the housing to an upper portion thereof, an image forming unit, having a corona discharge member, for forming an image on the recording medium transferred with the transfer unit, a passage body extending from the vicinity of the image forming unit to the communication opening of the housing, and having an air inlet port opened in the vicinity of the image forming unit and an air ejection port opened at the communication opening, and an air transferring device provided in the passage body for sucking air into the passage body through the air inlet port and ejecting air to the external communication opening of the housing from the air ejection port of the passage body.

### CROSS-REFERENCE TO RELATED APPLICATIONS

This application is based upon and claims the benefit of priority from the prior Japanese Patent Application No. 2000-091381, filed Mar. 29, 2000, the entire contents of which are incorporated herein by reference.

### BACKGROUND OF THE INVENTION

This invention relates to an image forming apparatus for forming an image by means of electrophotographic method on a recording medium moving in a vertical direction.

The image forming apparatus of this kind is used, for example, in a facsimile machine or a copying machine, or is used as a printer. FIG. 4 is a view schematically showing a vertical section of a conventional image forming apparatus which is constituted as a printer.

The conventional printer shown in FIG. 4 is detachably provided with a tray 14 for a recording medium at a predetermined position of a lower end portion of an inner space of an outer housing 10. The tray 14 for the recording medium holds a plurality of ordinary plain paper sheets each having a predetermined size as a recording medium in a mutually laminated state. In the inner space of the outer housing 10, there are further arranged a pick-up mechanism 16 for picking up one after another a plurality of paper sheets 12 in the tray 14 at an upper end thereof, and a transfer unit 20 for transferring the paper sheet 12, picked up from the plurality of paper sheets 12 in the tray 14 with the pick-up mechanism 16, in an upward direction in the inner space along a predetermined transfer path 18. In an upper wall of the outer housing 10 at a position corresponding to an upper end of the transfer path 18, an outlet opening 10a of the recording medium 10 is formed through which the paper sheet 12 ejected from the upper end of the transfer path 18 passes. On an upper surface of the upper wall of the outer housing 10, a tray 10b is formed on which the paper sheet 12 passed through the outlet opening 10a is stacked.

Further, in the inner space of the outer housing 10, an electrophotographic type image forming unit 22 is arranged at a predetermined position along the transfer path 18. The image forming unit 22 includes a photosensitive drum 22a which faces one of planar side surfaces of the paper sheet 12 being transferred in the transfer path 18, and is rotated in accordance with a transfer direction and a transfer speed of the paper sheet 18 in the transfer path 18.

The image forming unit 22 further includes a discharging device 22b, a charging device 22c, an exposing device 22d and a developing device 22e which are arranged along the external circumferential surface of the photosensitive drum 22a in this order in a rotation direction R of the photosensitive drum 22a.

The image forming unit 22 further includes a transfer device 22f and a separating device 22g arranged at two positions so that they face the external circumferential surface of the photosensitive drum 22a with the transfer path 18 interposed therebetween. The transfer device 22f is arranged on an upstream side than the separating device 22g in the rotation direction R of the photosensitive drum 22a. The image forming unit 22 further includes a fixing device 22h on a downstream side than the photosensitive drum 22a in the transfer direction of the paper sheet 12 in the transfer path 18.

The image forming unit 22 which is constituted as described above is provided with an operation controller 22i for controlling an operation of the image forming unit 22. The operation controller 22i is connected to an external data processing device (not shown) such as a personal computer or the like located outside of the image forming unit 22, and the controller 22i controls the operation of the image forming unit 22 on the basis of various operation control signal from the data processing device.

When the operation controller 22i receives an image formation start signal from the data processing device, the operation controller 22i makes the pick-up mechanism 16 pick up the upper most one paper sheet 22 from the tray 14, and makes a rotation of the photosensitive drum 22a stars at a predetermined speed in a predetermined rotation direction in correspondence to the pick-up of the paper sheet 22. At the same time, the operation controller 22i makes the discharging device 22b uniformly discharge the external circumferential surface of the photosensitive drum 22a being rotated, and makes the charging device 22c uniformly charge the external circumferential surface of the photosensitive drum 22a being rotated.

The exposing device 22d receives an image data signal from the data processing device through the operation controller 22i, and exposes the uniformly charged external circumferential surface of the photosensitive drum 22a in correspondence to the image data signal. Next, the developing device 22e develops the external circumferential surface of the photosensitive drum 22a with toner T to form a toner image at an exposed portion corresponding to the image data signal on the uniformly charged external circumferential surface.

The transfer unit 20 transfers the paper sheet 12 in the transfer path 18 such that an image formation start corresponding position on one plain side surface of the paper sheet 12, which corresponds to an image formation start position separated from the leading end on the other plain side surface of the sheet 12, faces the transfer device 22d when a leading end of the toner image on the external circumferential surface of the photosensitive drum 22a faces the transfer device 22d. Consequently, the transfer device 22d starts transferring the toner image on the external circumferential surface of the photosensitive drum 22a onto the other plain side surface (the image formation surface) of the paper sheet 12 at the image formation start position. Next, the separating device 22g separates the paper sheet 12 from the external circumferential surface of the photosensitive drum 22a while the toner image is held on the image formation surface on the paper sheet 12.

The paper sheet 12 separated from the external circumferential surface of the photosensitive drum 22a while holding the toner image is directed toward the fixing device 22h in the transfer path 18 by the transfer unit 20, and the fixing device 22h fixes the toner image onto the image formation surface of the paper sheet 12. The paper sheet 22h which has passed through the fixing device 22h is ejected from the upper end of the transfer path 18 onto the recording medium discharge tray 10b on the upper surface of the upper wall of the outer housing 10 through the outlet opening 10a of the upper wall of the outer housing 10.

In the conventional printer which is constituted in the above-mentioned manner and is operated in the above described manner, each of the charging device 22c, the transfer device 22f, and the separating device 22g has a high voltage wire HVW respectively. With the application of a high voltage to the high voltage wire HVW, the wire HVW generates a corona discharge to make each of the devices 22c, 22f, and 22c operate as described above.

The corona discharge ionizes oxygen molecules in the air so that ozone is generated. Ozone is toxic to the above described various devices and other members in the outer housing 10 of the conventional printer described above, particularly to a photosensitive layer of the external circumferential surface of the photosensitive drum 22a, thereby decreasing the life of these devices and members.

The conventional printer described above has a heat discharging fan for discharging heat generated from the above described various devices and other members in the inner space of the outer housing 1 to the outside space, and the heat discharging fan conveys ozone to the outside space together with heated air in the inner space of the outer housing 1.

However, an efficiency by which the heat discharging fan discharges air largely decreases with an increase in a space volume in which the heat discharging fan tries to discharge air and with an increase in a distance from the heat discharging fan. In the conventional printer, the space from which the heat discharging fan tries to discharge air is a whole of the inner space of the outer housing 1, and the inner space is relatively large. Furthermore, it is impossible to install the heat discharging fan in the vicinity of the image forming apparatus 22 in the inner space because the inner space is relatively crowded with various parts in the outer housing 1 in a recent trend in which an external size of an apparatus is demanded to be more smaller than the conventional one.

Consequently, in the conventional printer described above, ozone cannot be efficiently discharged out from the inner space of the outer housing to the outside and this fact hinders a prolongation of a life of the conventional printer, or the image forming apparatus. It is extremely important to prolong the life of the image forming apparatus in a waste-disposal problem in recent years.

This invention has been derived from the above circumstances, and an object of the invention is to provide an image forming apparatus which can efficiently remove ozone without hindering to make the external size of the image forming apparatus which generates ozone being smaller than that of the conventional one and which can further prolong the life of the image forming apparatus.

### BRIEF SUMMARY OF THE INVENTION

In order to achieve the above object, an image forming apparatus according to the present invention comprises:

an outer housing having an external communication opening;

a recording medium transfer unit for transferring a recording medium from a lower portion of the outer housing to an upper portion thereof;

an image forming unit, having a corona discharge member for conducting a corona discharge, for forming an image on the recording medium which is transferred with the transfer unit;

a hollow air ejection passage body extending from the vicinity of the image forming unit to the external communication opening of the outer housing, and having an air inlet port which is opened in the vicinity of the image forming unit and an air ejection port which is opened at the external communication opening; and

an air transferring device provided in the air ejection passage body for sucking air into the air ejection passage body through the air inlet port and ejecting air to the external communication opening of the outer housing from the air ejection port of the air ejection passage body.

In the image forming apparatus according to the present invention and characterized by being constituted in this manner, ozone generated in the corona discharge member of the image forming unit is sucked through the air inlet port which is opened in the vicinity of the image forming unit in the air ejection passage body into the air ejection passage body by the air transferring device provided in the hollow air ejection passage body. Furthermore, ozone sucked into the passage body is ejected from the air ejection port of the air ejection passage body to the air ejection opening of the outer housing. Since the air ejection passage body is extended from the vicinity of the image forming unit to the outside communication opening of the outer housing, ozone which is sucked into the air ejection passage body in the vicinity of the image forming unit does not spread out in the inner space of the outer housing from the air ejection passage body while the ozone is transferred to the external communication opening of the outer housing with the air transferring device.

Consequently, in the image forming apparatus in which ozone is generated, ozone can be efficiently removed without hindering to make the external size of the image forming apparatus being more smaller than that of the conventional one, and it is possible to prevent various above described devices and members in the inner space of the outer housing of the image forming apparatus from being damaged, so that the life of the image forming apparatus can be further prolonged.

In the image forming apparatus according to the present invention and constituted in the above described manner, preferably an ozone filter is provided in the air ejection passage body. As a consequence, this enables to prevent ozone from being ejected to the outside space from the outside communication opening of the outer housing.

In the image forming apparatus according to the present invention and constituted in the above described manner, preferably the air inlet port of the air ejection passage body is arranged under the corona discharge member of the image forming unit.

Ozone has a larger specific gravity than that of air, and ozone generated by the corona discharge member of the image forming unit moves downward with gravity. Consequently, when the air inlet port of the air ejection passage body is arranged under the corona discharge member of the image forming unit, ozone generated by the corona discharge member can be sucked into the air ejection passage body through the air inlet port of the air ejection passage body at a high efficiency.

In the image forming apparatus according to the present invention and constituted as described above, when the image forming unit has a photosensitive drum and forms an image with an electrophotographic method, the photosensitive drum is arranged adjacent to one side of a transfer track of the recording medium by the transfer unit, and the corona discharge member of the image forming unit is arranged adjacent to an external circumferential surface of the photosensitive drum on one side of the transfer track, it is preferable that the corona discharge member is arranged adjacent to the external circumferential surface of the photosensitive drum above a rotation center line of the photosensitive drum, and the air inlet port of the air ejection passage body is arranged below the rotation center line of the photosensitive drum and faces the external circumferential surface of the photosensitive drum along the rotation center line of the photosensitive drum on one side of the transfer track.

Since ozone having a larger specific gravity than that of air, moves downward with gravity after ozone is generated by the corona discharge member of the image forming unit, when the air inlet port of the air ejection passage member is also arranged under the corona discharge member of the image forming unit on one side of the transfer track, and the corona discharge member of the image forming unit is arranged adjacent to the external circumferential surface of the photosensitive drum on one side of the transfer track, ozone generated by the corona discharge member can be sucked into the air ejection passage body at a high efficiency through the air inlet port of the air ejection passage body.

Here, preferably, the air inlet port of the air ejection passage body is extended over an entire size in a direction along the rotation center line of the photosensitive drum on the external circumferential surface of the photosensitive drum. In such a structure, the external circumferential surface of the photosensitive drum which is particularly weak against ozone can be well protected from ozone.

In the image forming apparatus according to the present invention and constituted as described above, when the image forming unit includes a charging device for uniformly charging a whole of the external circumferential surface of the photosensitive drum, the charging device has a corona discharge member.

In the image forming apparatus according to the present invention and constituted as described above, when the image forming unit includes an exposing device for forming a desired electrostatic latent image by applying light to the external circumferential surface of the photosensitive drum for exposure, it is preferable that the image forming unit includes an exposure path through which light, applied to the external circumferential surface of the photosensitive drum from the exposing device, passes, the path being arranged below the rotation center line of the photosensitive drum and facing the external circumferential surface of the photosensitive drum along the rotation center line of the photosensitive drum. Further, the air inlet port of the air ejection passage body is arranged to face the exposure path.

In such structure, the air ejection passage body can be incorporated in the most compact manner to the electrophotographic type image forming unit in the outer housing.

In the image forming apparatus according to the present invention and constituted as described above, when the image forming unit has a photosensitive drum and forms an image with an electrophotographic method, the photosensitive drum is arranged adjacent to one side of a transfer track of the recording medium by the transfer unit, and the corona discharge member of the image forming unit is arranged on the other side of the transfer track, it is preferable that the corona discharge member is arranged adjacent to the external circumferential surface of the photosensitive drum approximately at the same level as that of the rotation center line of the photosensitive drum in the vertical direction or above the rotation center line, and the air inlet port of the air ejection passage body is arranged below the rotation center line of the photosensitive drum on the other side of the transfer track to face the external circumferential surface of the photosensitive drum along the rotation center line of the photosensitive drum.

Since ozone having a larger specific gravity than that of air, moves downward with gravity after ozone is generated by the corona discharge member of the image forming unit, when the corona discharge member of the image forming unit is arranged adjacent to the external circumferential surface of the photosensitive drum on the other side of the transfer track and the air inlet port of the air discharge member body is arranged under the corona discharge member of the image forming unit on the other side of the transfer track, ozone generated by the corona discharge member can be sucked into the air ejection passage body at a high efficiency through the air inlet port of the air ejection passage body.

In this case, it is preferable that the air inlet port of the air ejection passage body is extended over an entire size in a direction along the rotation center line of the photosensitive drum on the external circumferential surface of the photosensitive drum. In such a structure, the external circumferential surface of the photosensitive drum which is particularly weak against ozone can be well protected from ozone.

In the image forming apparatus according to the present invention and constituted as described above, when the image forming unit includes:

a charging device, arranged on one side of the transfer track, for uniformly charging the external circumferential surface of the photosensitive drum;

an exposing device for forming a desired electrostatic latent image by applying light to the external circumferential surface of the photosensitive drum which is uniformly charged with the charging device;

a developing device for developing with toner the electrostatic latent image exposed on the external circumferential surface of the photosensitive drum;

a toner image transfer device, arranged on the other side of the transfer track, for transferring a toner image developed from the latent image with toner on the external circumferential surface of the photosensitive drum to the recording medium which comes close to the outer circumferential surface of the photosensitive drum by the transfer unit; and

a separating device, arranged on the other side of the transfer track, for separating the recording medium from the external circumferential surface of the photosensitive drum, on the recording medium the toner image having been transferred from the photosensitive drum,

at least one of the transfer device or the separating device can have the corona discharge member.

In the image forming apparatus according to the present invention and constituted as described above, when the corona discharge member of the image forming unit is arranged on each of both sides of the transfer track of the recording medium by the transfer unit, it is preferable that the air inlet port of the air ejection passage body is also arranged under the corona discharge member on each of both sides of the transfer track.

Ozone has a larger specific gravity than that of air, and ozone generated by the corona discharge member of the image forming unit moves downward with gravity. Consequently, when the air inlet port of the air ejection passage body is arranged under the corona discharge member of the image forming unit on each of both sides of the transfer track, ozone generated by the corona discharge member can be sucked into the air ejection passage body through the air inlet port of the air ejection passage body at a high efficiency.

In the image forming apparatus according to the present invention and constituted as described above, when the image forming unit has a photosensitive drum and forms an image with an electrophotographic method, the photosensitive drum is arranged adjacent to one side of a transfer track of the recording medium by the transfer unit, and the corona discharge member is arranged on each of both sides of the transfer track in the image forming unit, it is preferable that the corona discharge member arranged on one side of the transfer track is arranged adjacent to the external circumferential surface of the photosensitive drum above a rotation center line of the photosensitive drum, the corona discharge member arranged on the other side of the transfer track is arranged approximately at the same level in the vertical direction as that of the rotation center line of the photosensitive drum or above the rotation center line of the photosensitive drum and faces to the external circumferential surface of the photosensitive drum, the air inlet port arranged on one side of the transfer track in the air ejection passage body is arranged below the rotation center line of the photosensitive drum to face the external circumferential surface of the photosensitive drum along the rotation center line of the photosensitive drum, and the air inlet port arranged on the other side of the transfer track in the air ejection passage body is arranged below the rotation center line of the photosensitive drum to face the external circumferential surface of the photosensitive drum along the rotation center line of the photosensitive drum.

Since ozone having a larger specific gravity than that of air moves downward with gravity after ozone is generated by the corona discharge member of the image forming unit, ozone generated by the corona discharge member arranged adjacent to the external circumferential surface of the photosensitive drum above the rotation center line of the photosensitive drum on one side of the transfer track is efficiently sucked into the air inlet port of the air ejection passage body arranged under the corona discharge member of the image forming unit on one side of the transfer track, and ozone generated by the corona discharge member arranged approximately at the same level in the vertical direction as that of the rotation center line of the photosensitive drum or above the rotation center line of the photosensitive drum on the other side of the transfer track to face the external circumferential surface of the photosensitive drum can be efficiently sucked into the air inlet port of the air ejection passage body arranged under the corona discharge member of the image forming unit on the other side of the transfer track.

In this constitution, it is preferable that the air inlet port of the air ejection passage body arranged on each of both sides of the transfer track is extended over the entire size in a direction along the rotation center line of the photosensitive drum on the external circumferential surface of the photosensitive drum. In such a structure, the external circumferential surface of the photosensitive drum which is particularly weak against ozone can be well protected from ozone.

In the image forming apparatus according to the present invention and constituted as described above, when the image forming unit includes:

a charging device, arranged on one side of the transfer track, for uniformly charging the external circumferential surface of the photosensitive drum;

an exposing device for forming a desired electrostatic latent image by applying light to the external circumferential surface of the photosensitive drum which is uniformly charged with the charging device;

a developing device for developing with toner the electrostatic latent image exposed on the external circumferential surface of the photosensitive drum with the toner;

a toner image transfer device, arranged on the other side of the transfer track, for transferring a toner image developed from the latent image with toner on the external circumferential surface of the photosensitive drum to the recording medium which comes close to the outer circumferential surface of the photosensitive drum by the transfer unit; and

a separating device, arranged on the other side of the transfer track, for separating the recording medium from the external circumferential surface of the photosensitive drum, on the recording medium the toner image having been transferred from the photosensitive drum,

the charging device can have the corona discharge member and at least one of the transfer device and the separating device can have the corona discharge member.

Also, in the image forming apparatus according to the present invention and constituted as described above, it is preferable that the image forming unit includes an exposure path through which light, applied to the external circumferential surface of the photosensitive drum from the exposing device, passes the path being arranged below the rotation center line of the photosensitive drum and facing the external circumferential surface of the photosensitive drum along the rotation center line of the photosensitive drum, and the air inlet port arranged on one side of the transfer track in the air ejection passage body is arranged to face the exposure path.

In such a structure, the air ejection passage body can be incorporated in the most compact manner in the electrophotographic image forming unit in the outer housing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic vertical sectional view of a printer according to one embodiment of an image forming apparatus of the present invention;

FIG. 2 is a schematic horizontal sectional view taken along line II-II of the printer of FIG. 1;

FIG. 3 is an enlarged perspective view of an air ejection passage body of the printer; and

FIG. 4 is a schematic vertical sectional view of a printer constituted of a conventional image forming apparatus.

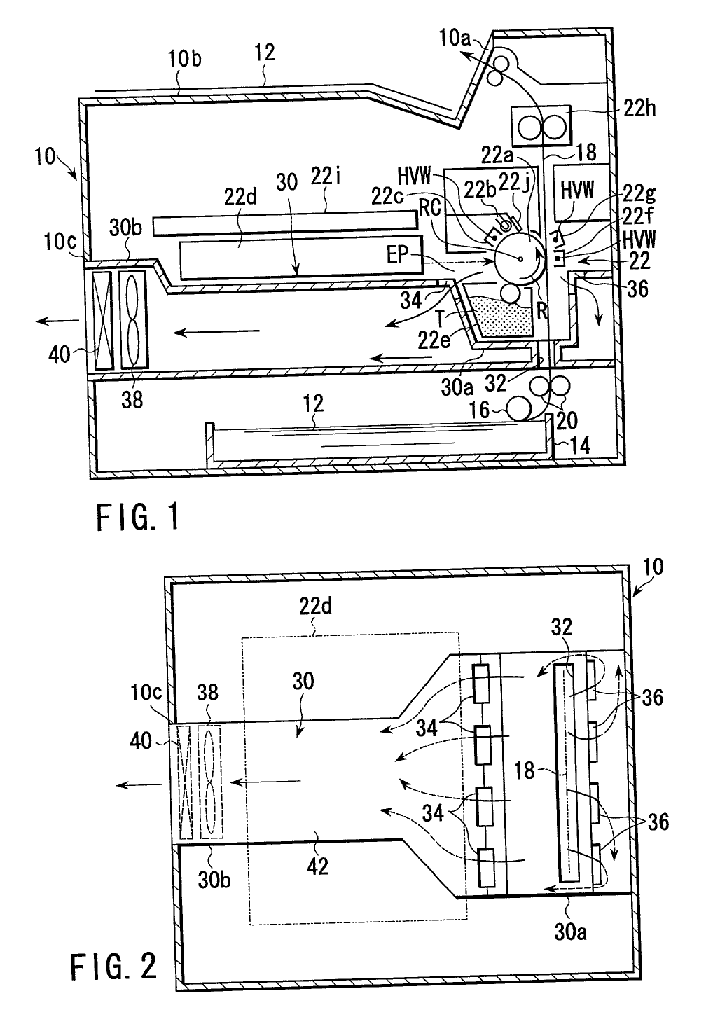

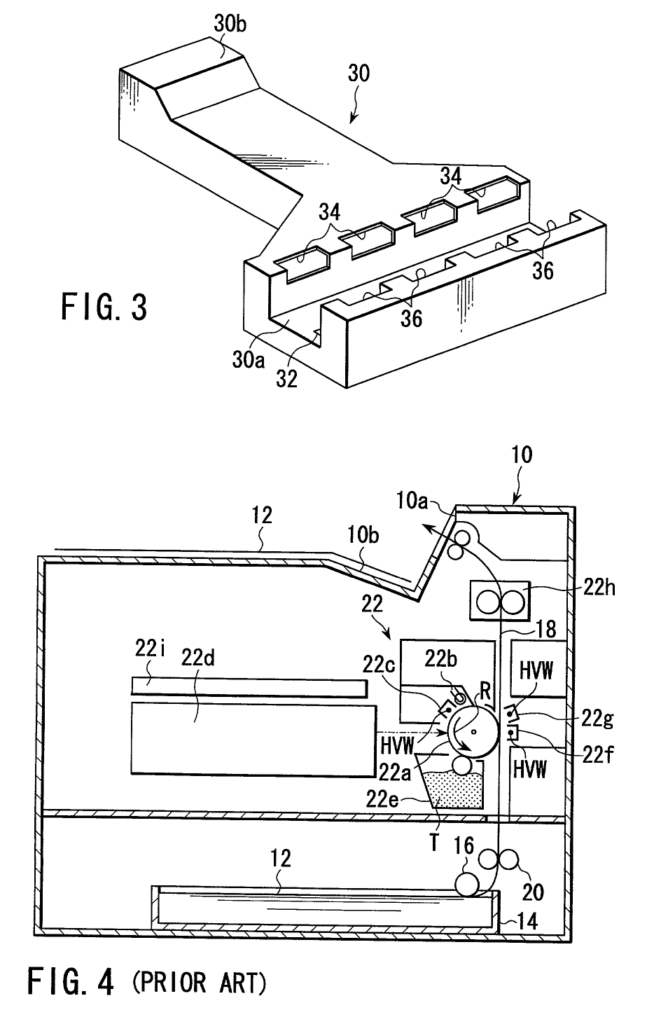

Hereinafter, the printer according to one embodiment of the image forming apparatus of the present invention will be explained in detail by referring to FIGS. 1 through 3.

### DETAILED DESCRIPTION OF THE INVENTION

A basic structure of the printer according one embodiment of this invention is the same as a basic structure of the printer constituted of the conventional image forming apparatus described above with reference to FIG. 4. In FIG. 1 through FIG. 3 showing the printer according to one embodiment of the image forming apparatus of this invention, constituent members which are the same as those of the conventional printer are denoted by the same reference numerals as those denoting the constituent members of the conventional printer of FIG. 4, which correspond to the constituent members of the present invention, and a detailed explanation thereof will be omitted.

In this embodiment, the image forming unit 22 has a cleaner 22j adjacent to an upstream side of the discharging device 22b in a predetermined rotation direction R of the photosensitive drum 22a along the external circumferential surface of the photosensitive drum 22a. The cleaner 22j removes toner deposited on the external circumferential surface of the photosensitive drum 22a.

When an arrangement of a plurality of constituent devices or members of the image forming unit 22 in the outer housing 10 is explained by referencing the transfer track (corresponding to the transfer path 18) of the recording medium 12 which is transferred in the transfer path 18 with the transfer unit 20 from the lower tray 14 in the inner space of the outer housing 10 to the outlet opening 10a of the upper wall of the outer housing 10, the photosensitive drum 22a is arranged on one side of the transfer track.

The external circumferential surface of the photosensitive drum 22a is located adjacent to the transfer track. Furthermore, around the external circumferential surface of the photosensitive drum 22a on one side of the transfer track, the cleaner 22j, the discharging device 22b, the charging device 22c, the exposing device 22d, and the developing device 22e are arranged in this order in the predetermined rotation direction R of the photosensitive drum 22a.

The cleaner 22j, the discharging device 22b, the charging device 22c, and the developing device 22e are arranged adjacent to the external circumferential surface of the photosensitive drum 22a, and the exposing device 22d larger than the cleaner 22j, the discharging device 22b, the charging device 22c, and the developing device 22e is arranged at a position separated in a certain distance from the external circumferential surface of the photosensitive drum 22a, so that it is possible to make the image forming unit 22 being compact without an interference of the exposing device 22d with the cleaner 22j, the discharging device 22b, the charging device 22c, and the developing device 22e. The cleaner 22j, the discharging device 22b, the charging device 22c, and the developing device 22e are constituted as an integrated block. An exposure path EP is set between the charging device 22c and the developing device 22e around the external circumferential surface of the photosensitive drum 22a, and the exposure path EP allows light applied from the exposing device 22d toward the external circumferential surface of the photosensitive drum 22a to reach at the external circumferential surface of the photosensitive drum 22a. (In this embodiment, the light from the exposing device 22d is a laser beam and is denoted by an arrow of a two-dots chain line in FIG. 1.)

On the other side of the above described transfer track, the transfer device 22f and the separating device 22g are arranged in this order along the predetermined rotation direction R of the photosensitive drum 22a and to face the external circumferential surface of the photosensitive drum 22a. The transfer device 22f is located adjacent to the external circumferential surface of the photosensitive drum 22a, and the separating device 22g is separated in a certain distance from the external circumferential surface of the photosensitive drum 22g.

Next, when the arrangement of a plurality of constituent devices or members of the image forming unit 22 is explained by referencing the rotation center line RC of the photosensitive drum 22a, the cleaner 22j, the discharging device 22b, and the charging device 22c are arranged above the rotation center line RC on one side of the above described transfer track, the exposing device 22d and the exposure path EP are located at approximately the same level as that of the rotation center line RC in the vertical direction, and the developing device 22e is located below the rotation center line RC. On the other side of the above described transfer track, the transfer device 22f is arranged at approximately the same level as that of the rotation center line RC and the separating device 22g is arranged above the rotation center line RC.

In this embodiment, the charging device 22c located above the rotation center line RC on one side of the transfer track around the external circumferential surface of the photosensitive drum 22a, and the transfer device 22f located at approximately the same level as that of the rotation center line RC and the separating device 22g located above the rotation center line RC on the other side of the transfer track around the external circumferential surface of the photosensitive drum 22a have high voltage wire HVW respectively. The high voltage wire HVW extends in the same direction as the rotation center line RC in parallel to the rotation center line RC of the photosensitive drum 22a and extends in an equal distance to the entire size of the external circumferential surface of the photosensitive drum 22a in the same direction as the rotation center line RC.

A difference of the image forming apparatus according to the present invention from the above described conventional image forming device shown in FIG. 4 is that an air ejection passage body 30 is provided between the image forming unit 22 and the recording medium cassette 14 in the outer housing 10. The air ejection passage body 30 is hollow, is extended from a position located under the image forming unit 22 to an air ejection opening 10c (external communication opening) formed on a predetermined position of side walls of the outer housing 10, and is connected to the air ejection opening 10c. The predetermined position is set to a surface (rear surface) facing a direction opposite to a surface (front surface) normally directed to users when the image forming apparatus according to the embodiment is used.

One end portion 30a located under the image forming unit 22 in the air ejection passage body 30 is provided with a transfer path passage opening 32 for allowing the transfer path 18 to pass therethrough. The one end portion 30a further comprises first air inlet ports 34 at a position located adjacent to the exposure path EP of the image forming unit 22 and facing the exposure path EP on one side of the transfer path 18. The one end portion 30s more further comprises second air inlet ports 36 at a position location adjacent to the transfer device 22f and the separating device 22g of the image forming unit 22 and facing them on the other side of the transfer path 18.

The first air inlet ports 34 and the second air inlet ports 36 are respectively extended in the same direction as that of the rotation center line CR in parallel to the rotation center line CR of the photosensitive drum 22a and are extended over the entire size of the external circumferential surface of the photosensitive drum 22a in the same direction as that of the rotation center line CR.

The other end portion 30b connected to the air ejection opening 10c of the outer housing 10 in the air ejection passage body 30 is provided with an air transferring device 38 and an ozone filter 40. In this embodiment, the air transferring device 38 is constituted of an air discharge fan.

The air ejection passage body 30 constituted as described above operates the air transferring device 38 while the image forming unit 22 is operated for the image formation. The air transferring device 38 forms in the inner space of the air ejection passage body 30 an air stream which is directed from the first and the second air inlet ports 34 and 36 of one end portion 30a located under the image forming unit 22 to the other end portion 30b connected to the air ejection opening 10c of the outer housing 10.

While the image forming unit 22 is operated for the image formation, the high voltage wires HVW incorporated in the charging device 22c located above the rotation center line RC on one side of the transfer track (the transfer path 18), the transfer device 22f located at approximately the same level in the vertical direction as that of the rotation center line RC and the separating device 22g located above the rotation center line RC on the other side of the transfer track (the transfer path 18) conduct the corona discharge and generate ozone. Since ozone is heavier in gravity than air, ozone goes down along the external circumferential surface of the photosensitive drum 22a and reaches at the vicinity of the first air inlet ports 34 and the second air inlet ports 36 of the air ejection passage body 30. Ozone is sucked into the inner space of the air ejection passage body 30 through the first air inlet ports 34 and the second air inlet ports 36 by an air stream formed in the inner space of the air ejection passage body with the air transferring device 38, so that the ozone is trapped with the ozone filter 40 after ozone is transferred in the inner space of the air ejection passage body 30. Thus, no ozone is ejected from the air ejection opening 10b of the outer housing 10. Furthermore, since no ozone sucked into the air ejection passage body 30 is leaked from the air ejection passage body 30 to the inner space of the outer housing 10, various devices and members in the inner space of the outer housing 10 is not contaminated with ozone.

The first air inlet ports 34 and the second air inlet ports 36, which are extended in the same direction as that of the rotation center line CR in parallel to the rotation center line CR of the photosensitive drum 22a and which are extended over the entire size of the external circumferential surface of the photosensitive drum 22a in the same direction as that of the rotation center line CR of the photosensitive drum 22a, can efficiently trap ozone generated on both sides of the transfer track (the transfer path 18).

In the above described embodiment, since the image forming unit 22 includes ozone generating members (namely, the high voltage wires HVW of the charging device 22c, the transfer device 22f, and the separating device 22g) on both sides of the transfer track (the transfer path 18), the one end portion 30a of the air ejection passage body 30 located under the image forming unit 22 also has the first and second air inlet ports 34 and 36 for sucking ozone at positions under the ozone generating members on both sides of the transfer track (the transfer path 18). However, when the image forming unit 22 includes the ozone generating member (s) (the high voltage wire HVW of the charging device 22c or the high voltage wires HBW of the transfer device 22f and the separating device 22g) only on any one side of the transfer track (the transfer path 18), one end portion 30a of the air ejection passage body 30 located under the image forming unit 22 may only have any one of the group of the first air inlet ports 34 and the group of the second air inlet ports 36 for sucking ozone under the ozone generating member on any one of the both sides of the transfer track (the transfer path 18). On the other side of the both sides of the transfer track (the transfer path 18) which does not have the ozone generating member, the other one of the group of the first air inlet ports 34 and the group of the second air inlet ports 36 can be omitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an outer housing having an external communication opening;
a recording medium transfer unit for transferring a recording medium from a lower portion of the outer housing to an upper portion thereof;
an image forming unit, having a corona discharge member for conducting a corona discharge, for forming an image on the recording medium which is transferred with the transfer unit;
a hollow air ejection passage body extending from the vicinity of the image forming unit to the external communication opening of the outer housing, and having an air inlet port which is opened in the vicinity of the image forming unit and an air ejection port which is opened at the external communication opening; and
an air transferring device, provided in the air ejection passage body for sucking air into the air ejection passage body, through the air inlet port and ejecting air to the external communication opening of the outer housing from the air ejection port of the air ejection passage body.

2. An image forming apparatus according to claim 1, wherein ozone generated with the corona discharge of the image forming unit is sucked into the air ejection passage body through the air inlet port, and the air ejection passage body is provided with an ozone filter for adsorbing ozone.

3. An image forming apparatus according to claim 1, wherein the air inlet port of the air ejection passage body is arranged under the corona discharge member of the image forming unit.

4. An image forming apparatus according to claim 1, wherein the image forming unit has a photosensitive drum and forms an image with an electrophotographic method, the photosensitive drum is arranged adjacent to one side of a transfer track of the recording medium by the transfer unit,
the corona discharge member of the image forming unit is arranged adjacent to an external circumferential surface of the photosensitive drum above a rotation center line of the photosensitive drum on one side of the transfer track, and the air inlet port of the air ejection passage body is arranged below the rotation center line of the photosensitive drum and faces the external circumferential surface of the photosensitive drum along the rotation center line of the photosensitive drum on one side of the transfer track.

5. An image forming apparatus according to claim 4, wherein the air inlet port of the air ejection passage body is extended over an entire size in a direction along the rotation center line of the photosensitive drum on the external circumferential surface of the photosensitive drum.

6. An image forming apparatus according to claim 4, wherein the image forming unit includes a charging device for uniformly charging the external circumferential surface of the photosensitive drum and the charging device has a corona discharge member.

7. An image forming apparatus according to claim 4, wherein the image forming unit includes an exposing device for forming a desired electrostatic latent image by applying light to the external circumferential surface of the photosensitive drum for exposure, and an exposure path through which light, applied to the external circumferential surface of the photosensitive drum from the exposing device, passes, the path being arranged below the rotation center line of the photosensitive drum and facing the external circumferential surface of the photosensitive drum along the rotation center line of the photosensitive drum, and the air inlet port of the air ejection passage body is arranged to face the exposure path.

8. An image forming apparatus according to claim 1, wherein the image forming apparatus has a photosensitive drum, and forms an image with an electrophotographic method, the photosensitive drum is arranged adjacent to one side of a transfer track of the recording medium by the transfer unit,
the corona discharge member of the image forming unit is arranged adjacent to an external circumferential surface of the photosensitive drum above a rotation center line of the photosensitive drum on the other side of the transfer track, and the air inlet port of the air ejection passage body is arranged below the rotation center line of the photosensitive drum and faces the external circumferential surface of the photosensitive drum along the rotation center line of the photosensitive drum on the other side of the transfer track.

9. An image forming apparatus according to claim 8, wherein the air inlet port of the air ejection passage is extended over an entire size in a direction along the rotation center line of the photosensitive drum on the external circumferential surface of the photosensitive drum.

10. An image forming apparatus according to claim 8, wherein the image forming unit includes:
a charging device, arranged on one side of the transfer track, for uniformly charging the external circumferential surface of the photosensitive drum;
an exposing device for forming a desired electrostatic latent image by applying light to the external circumferential surface of the photosensitive drum which is uniformly charged with the charging device;
a developing device for developing with toner the electrostatic latent image exposed on the external circumferential surface of the photosensitive drum;
a toner image transfer device, arranged on the other side of the transfer track, for transferring a toner image developed from the latent image with toner on the external circumferential surface of the photosensitive drum to the recording medium which comes close to the outer circumferential surface of the photosensitive drum by the transfer unit; and
a separating device, arranged on the other side of the transfer track, for separating the recording medium from the external circumferential surface of the photosensitive drum, on the recording medium the toner image having been transferred from the photosensitive drum, and
at least one of the transfer device and the separating device has the corona discharge member.

11. An image forming apparatus according to claim 1, wherein the corona discharge member of the image forming unit is arranged respectively on each of both sides of the transfer track of the recording medium, and the air inlet port of the air ejection passage body is also arranged respectively under the corona discharge member on each of both sides of the transfer track.

12. An image forming apparatus according to claim 11, wherein the image forming unit has a photosensitive drum and forms an image with an electrophotographic method, the photosensitive drum is arranged adjacent to one side of a transfer track of the recording medium by the transfer unit, the corona discharge member arranged on one side of the transfer track in the image forming unit is arranged adjacent to the external circumferential surface of the photosensitive drum above a rotation center line of the photosensitive drum, the air inlet port arranged on one side of the transfer track in the air ejection passage body is arranged to face the external circumferential surface of the photosensitive drum along the rotation center line of the photosensitive drum below the center line of rotation of the photosensitive drum, the corona discharge member arranged on the other side of the transfer track is arranged at approximately the same level in a vertical direction as that of the rotation center line of the photosensitive drum or above the rotation center line and faces the external circumferential surface of the photosensitive drum, and the air inlet port arranged on the other side of the transfer track in the air ejection passage body is arranged below the rotation center line of the photosensitive drum and faces the external circumferential surface of the photosensitive drum along the rotation center line of the photosensitive drum.

13. An image forming apparatus according to claim 12, wherein the air inlet port arranged respectively on each of both sides of the transfer track in the air ejection passage body is extended over the entire size in a direction along the rotation center line of the photosensitive drum on the external circumferential surface of the photosensitive drum.

14. An image forming apparatus according to claim 13, wherein the image forming unit includes:
a charging device, arranged on one side of the transfer track, for uniformly charging the external circumferential surface of the photosensitive drum;
an exposing device for forming a desired electrostatic latent image by applying light to the external circumferential surface of the photosensitive drum which is uniformly charged with the charging device;
a developing device for developing with toner the electrostatic latent image exposed on the external circumferential surface of the photosensitive drum;
a toner image transfer device, arranged on the other side of the transfer track, for transferring a toner image developed from the latent image with toner on the external circumferential surface of the photosensitive drum to the recording medium which comes close to the outer circumferential surface of the photosensitive drum by the transfer unit; and
a separating device, arranged on the other side of the transfer track, for separating the recording medium from the external circumferential surface of the photosensitive drum, on the recording medium the toner image having been transferred from the photosensitive drum, and
the charging device has the corona discharge member and at least one of the transfer device and the separating device has the corona discharge member.

15. An image forming apparatus according to claim 11, wherein the image forming unit includes an exposure path through which light, applied to the external circumferential surface of the photosensitive drum from the exposing device, passes, the path being arranged below the rotation center line of the photosensitive drum and facing the external circumferential surface of the photosensitive drum along the rotation center line of the photosensitive drum, and the air inlet port arranged on one side of the transfer track in the air ejection passage body is arranged to face the exposure path.
